(19) United States
(12) Patent Application Publication
(10) Pub. No.: US 2011/0015336 A1
(43) Pub. Date: Jan. 20, 2011

(54) Curable Silicone Compositions

(75) Inventor: Andreas Koellnberger, Marktl (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/835,871

(22) Filed: Jul. 14, 2010

(30) Foreign Application Priority Data
Jul. 20, 2009 (DE) 10 2009 027 847.8

(51) Int. Cl. C08L 43/04; C08F 4/80

(52) U.S. Cl. 524/547; 526/126

(57) ABSTRACT

The present invention relates to silicone compositions which can be crosslinked thermally by hydrosilylation, processes for producing them and also the use of the crosslinkable compositions.

### CROSS-REFERENCE TO RELATED APPLICATIONS

This application claims priority to German Patent Application No. DE 10 2009 027 847.8 filed Jul. 20, 2009 which is herein incorporated by reference.

### BACKGROUND OF THE INVENTION

1. Field of the Invention

The present invention relates to silicone compositions which can be crosslinked thermally by hydrosilylation, processes for producing them, and to the use of the crosslinkable compositions.

2. Background Art

To crosslink addition-crosslinking silicone compositions by means of the hydrosilylation reaction, a catalyst which typically contains platinum or a metal of the platinum group is generally used. In the catalytic reaction, aliphatically unsaturated groups are reacted with Si-bonded hydrogen to form network structures.

In the case of two-component systems, the reactive constituents are mixed only shortly before processing. The mixtures contain an active platinum catalyst, as a result of which the crosslinking reaction proceeds even at room temperature and the time for processing (pot life) is strictly limited. This results in disadvantages such as an additional mixing step, an increased outlay for cleaning in the case of technical malfunctions and the risk of platinum contamination in vessels.

There has been a long felt need for one-component addition-crosslinking silicone rubber systems which ideally do not cure at all at room temperature and cure very quickly at elevated temperature.

There are various approaches to solving the problem of premature crosslinking at room temperature. One possibility is to encapsulate the catalyst in a thermoplastic material which melts at elevated temperature and thereby sets the active catalyst free, as described, for example, in EP 0 459 464 A2. However, the production of the catalyst is relatively complicated.

A further possible method of preventing premature crosslinking of one-component systems at room temperature is the use of specific platinum complexes. Platinum-alkynyl complexes have been described in U.S. Pat. No. 6,252,028 B and in U.S. Pat. No. 6,359,098 B. Pt(0)-phosphine and -phosphite complexes in combination with tin salts are used in U.S. Pat. No. 4,256,616 A, and WO 03/098 890 A1 describes Pt(0)-phosphite complexes which contain both phosphite ligands and divinyldisiloxane ligands as structural features.

A further, fundamentally different possibility is to use inhibitors which are added to the mixture as additives in order to extend the pot life. They are always used in a molar excess over the catalyst component and inhibit its catalytic activity. However, an increasing amount of inhibitor results not only in a lengthening of the pot life but also a decrease in the reactivity of the system at elevated temperatures and an increase in the initiation temperature. There are numerous examples of inhibitors from various classes of substances in the literature. U.S. Pat. No. 3,723,567 A claims amino-functional silanes as inhibitors. Alkyldiamines in combination with an acetylenically unsaturated alcohol are used for inhibition in U.S. Pat. No. 5,270,422 A. EP 0 761 759 A2 claims a combination of inhibitors; an amine together with an acetylene alcohol as a further inhibitor is used. DE 19 757 221 A1 likewise describes the class of phosphites for use as an inhibitor. Phosphines are claimed in U.S. Pat. No. 4,329,275 A as additive for inhibition. A combination of phosphites with organic peroxides is described by EP 1 437 382 A1. Apart from adverse effects on the crosslinking kinetics, the use of sometimes volatile inhibitors or inhibitors which liberate volatile constituents is likewise disadvantageous. Mixtures which display complete inhibition at room temperature and no effect at all on the reaction rate under curing conditions by use of an appropriate additive have hitherto been unknown.

Although the compositions previously described provide significantly improved pot lives and at times, a sufficient crosslinking rate for addition-crosslinking compositions formulated as one component, there continues to be a need for higher-performance platinum catalysts which ensure rapid crosslinking of the material at elevated temperature but do not display the abovementioned disadvantages.

### SUMMARY OF THE INVENTION

It was an object of the present invention to provide addition-crosslinking compositions which do not display the abovementioned disadvantages and allow significantly improved pot lives combined with a good crosslinking rate.

These and other objects are achieved through the use of addition curable organosilicon compositions which crosslink through hydrosilylation, which contain an inhibitor system comprising a hydroperoxide and an acetylenic alcohol.

### DETAILED DESCRIPTION OF THE PREFERRED EMBODIMENT(S)

In the following, the term “organopolysiloxanes” encompasses polymeric, oligomeric and also dimeric siloxanes.

The present patent application provides addition-crosslinking silicone compositions of the following compositions:

at least one compound each of (A), (B), (D), (K) and (L),

at least one compound each of (C), (D), (K) and (L)

or

at least one compound each of (A), (B), (C), (D), (K) and (L),

where
(A) is an organic compound or an organosilicon compound containing at least two radicals having aliphatic carbon-carbon multiple bonds,
(B) is an organosilicon compound containing at least two Si-bonded hydrogen atoms,
(C) is an organosilicon compound containing SiC-bonded radicals having aliphatic carbon-carbon multiple bonds and Si-bonded hydrogen atoms,
(D) is a platinum catalyst,
(K) is a hydroperoxide, and
(L) is an acetylenic alcohol.

It has surprisingly been discovered that the use of a combination of one or more acetylenic alcohols (L) with one or more hydroperoxides (K) results in a synergistic effect so that the start temperature increases only moderately while the pot life is significantly improved. This effect cannot be achieved solely by use of individual inhibitors.

The compositions of the invention can be one-component silicone compositions and also two-component silicone compositions. In the latter case, the two components of the compositions of the invention can contain all constituents in any combination, generally with the proviso that a component does not simultaneously contain siloxanes having an aliphatic multiple bond, siloxanes having Si-bonded hydrogen and catalyst, i.e. essentially not simultaneously the constituents (A), (B) and (D), or the constituents (C) and (D). However, the compositions of the invention are preferably one-component compositions.

The compounds (A) and (B) and (C) used in the compositions of the invention are, as is known, selected so that crosslinking is possible. Thus, for example, compound (A) may have at least two aliphatically unsaturated radicals and (B) may have at least three Si-bonded hydrogen atoms, or compound (A) may have at least three aliphatically unsaturated radicals and siloxane (B) may have at least two Si-bonded hydrogen atoms, or else siloxane (C) which has aliphatically unsaturated radicals and Si-bonded hydrogen atoms in ratios of from 0.1 to 10, preferably from 0.2 to 5, is used instead of compounds (A) and (B). Mixtures of (A) and (B) and (C) having the abovementioned ratios of aliphatically unsaturated radicals and Si-bonded hydrogen atoms are also possible.

The compound (A) used according to the invention can be a silicon-free organic compound having preferably at least two aliphatically unsaturated groups or an organosilicon compound preferably having at least two aliphatically unsaturated groups, or a mixture thereof.

Examples of silicon-free organic compounds (A) are 1,3,5-trivinylcyclohexane, 2,3-dimethyl-1,3-butadiene, 7-methyl-3-methylene-1,6-octadiene, 2-methyl-1,3-butadiene, 1,5-hexadiene, 1,7-octadiene, 4,7-methylene-4,7,8,9-tetrahydroindene, methylcyclopentadiene, 5-vinyl-2-norbornene, bicyclo [2.2.1]hepta-2,5-diene, 1,3-diisopropenylbenzene, polybutadiene containing vinyl groups, 1,4-divinylcyclohexane, 1,3,5-triallylbenzene, 1,3,5-trivinylbenzene, 1,2,4-trivinylcyclohexane, 1,3,5-triisopropenylbenzene, 1,4-divinylbenzene, 3-methyl-1,5-heptadiene, 3-phenyl-1,5-hexadiene, 3-vinyl-1,5-hexadiene and 4,5-dimethyl-4,5-diethyl-1,7-octadiene, N,N′-methylenebisacrylamide, 1,1,1-tris(hydroxymethyl)propane triacrylate, 1,1,1-tris(hydroxymethyl)propane trimethacrylate, tripropylene glycol diacrylate, diallyl ether, diallylamine, diallyl carbonate, N,N′-diallylurea, triallylamine, tris(2-methylallyl)amine, 2,4,6-triallyloxy-1,3,5-triazine, triallyl-s-triazine-2,4,6(1H,3H,5H)trione, diallyl malonate, polyethylene glycol diacrylate, polyethylene glycol dimethacrylate, and polypropylene glycol) methacrylate.

The silicone compositions of the invention preferably contain, as constituent (A), at least one aliphatically unsaturated organosilicon compound. It is possible to use all aliphatically unsaturated organosilicon compounds which are useful in addition-crosslinking compositions, for example silicone block copolymers with urea segments, silicone block copolymers with amide segments, imide segments, esteramide segments, polystyrene segments, silarylene segments, or carborane segments, silicone polymers containing more than one of the aforementioned segments, and silicone graft copolymers having ether groups.

As organosilicon compounds (A) which have SiC-bonded radicals having aliphatic carbon-carbon multiple bonds, preference is given to using linear or branched organopolysiloxanes composed of units of the general formula (II)

RₐR⁴_{b}SiO_{(4-a-b)/2} (II),

where
the radicals R are identical or different and are each, independently of one another, an organic or inorganic radical which is free of aliphatic carbon-carbon multiple bonds,
the radicals R⁴ are identical or different and are each, independently of one another, a monovalent, substituted or unsubstituted, SiC-bonded hydrocarbon radical having at least one aliphatic carbon-carbon multiple bond,
a is 0, 1, 2 or 3 and
b is 0, 1 or 2,
   with the proviso that the sum a+b is less than or equal to 3 and there are at least 2 radicals R⁴ per molecule.

The radicals R can be monovalent or polyvalent radicals, with the polyvalent radicals, for example bivalent, trivalent or tetravalent radicals, which then joining a plurality of, for instance, two, three or four, siloxy units of the formula (II) to one another.

Further examples of R are the monovalent radicals —F, —Cl, —Br, OR⁵, —CN, —SCN, —NCO and SiC-bonded, substituted or unsubstituted hydrocarbon radicals which may be interrupted by oxygen atoms or the group —C(O)—, and also divalent radicals bound at both ends via Si as per formula (II). If the radical R is an SiC-bonded, substituted hydrocarbon radical, preferred substituents are halogen atoms, phosphorus-containing radicals, cyano radicals, —OR⁵, —NR⁵—, —NR⁵₂, —NR⁵—C(O)—NR⁵₂, —C(O)—NR⁵₂, —C(O)R⁵, —C(O)OR⁵, —SO₂-Ph and —C₆F₅. Here, the radicals R⁵ are identical or different and are each a hydrogen atom or a monovalent hydrocarbon radical having from 1 to 20 carbon atoms and Ph is the phenyl radical.

Examples of radicals R are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical and octadecyl radicals such as the n-octadecyl radical; cycloalkyl radicals such as cyclopentyl, cyclohexyl, cycloheptyl and methylcyclohexyl radicals; aryl radicals such as the phenyl, naphthyl, anthryl and phenanthryl radicals; alkaryl radicals such as o-, m-, p-tolyl radicals, xylyl radicals and ethylphenyl radicals; and aralkyl radicals such as the benzyl radical, and the α- and the β-phenylethyl radicals.

Examples of substituted radicals R are haloalkyl radicals such as the 3,3,3-trifluoro-n-propyl radical, the 2,2,2,2′,2′,2′-hexafluoroisopropyl radical, the heptafluoroisopropyl radical, haloaryl radicals such as the o-, m- and p-chlorophenyl radicals, —(CH₂)—N(R⁵)C(O)NR⁵₂, —(CH₂)ₙ—C(O)NR⁵₂, —(CH₂)ₙ—C(O)R⁵, —(CH₂)ₙ—C(O)OR⁵, —(CH₂)ₙ—C(O)NR⁵₂, —(CH₂)—C(O)—(CH₂)ₘC(O)CH₃, —(CH₂)—O—CO—R⁵, —(CH₂)—NR^{S}—(CH₂)ₘ—NR⁵₂, —(CH₂)ₙ—O—(CH₂)ₘCH(OH)CH₂OH, —(CH₂)ₙ(OCH₂CH₂)ₘOR⁵, —(CH₂)ₙ—SO₂-Ph and —(CH₂)ₙ—O—C₆F₅, where R⁵ and Ph are as defined above and n and m are identical or different integers in the range from 0 to 10.

Examples of R are divalent radicals which are Si-bonded at both ends as per formula (II) and are derived from the monovalent examples given above for the radical R in that an additional bond is formed by replacement of a hydrogen atom; examples of such radicals are —(CH₂)—, —CH(CH₃)—, —C(CH₃)₂—, —CH(CH₃)—CH₂—, —C₆H₄—, —CH(Ph)-CH₂—, —C(CF₃)₂—, —(CH₂)ₙ—C₆H₄—(CH₂)ₙ—, —(CH₂)ₙ—C₆H₄—C₆H₄—(CH₂)ₙ—, —(CH₂O)ₘ, (CH₂CH₂O)ₘ, and —(CH₂)ₙ—Oₓ—C₆H₄—SO₂—C₆H₄—Oₓ—(CH₂)ₙ—, where x is 0 or 1 and Ph, m and n are as defined above.

The radical R is preferably a monovalent, SiC-bonded, substituted or unsubstituted hydrocarbon radical which is free of aliphatic carbon-carbon multiple bonds and has from 1 to 18 carbon atoms, more preferably a monovalent, SiC-bonded hydrocarbon radical which is free of aliphatic carbon-carbon multiple bonds and has from 1 to 6 carbon atoms, and in particular, the methyl or phenyl radical.

Radicals R⁴ can be any groups which are capable of an addition reaction (hydrosilylation) with an SiH-functional compound. If the radical R⁴ is an SiC-bonded, substituted hydrocarbon radical, preferred substituents are halogen atoms, cyano radicals and —OR⁵, where R⁵ is as defined above.

The radicals R⁴ are preferably alkenyl and alkynyl groups having from 2 to 16 carbon atoms, e.g. vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl and styryl radicals, with vinyl, allyl and hexenyl radicals being particularly preferred.

The molecular weight of the constituent (A) can vary within wide limits, for instance in the range from 10² to 10⁶ g/mol. Thus, the constituent (A) can be, for example, a relatively low molecular weight alkenyl-functional oligosiloxane, such as 1,2-divinyltetramethyldisiloxane, but can also be a high-polymer polydimethylsiloxane having lateral or terminal Si-bonded vinyl groups, e.g. a polydimethylsiloxane of this type having a molecular weight of 10⁵ g/mol (number average determined by means of NMR). The structure of the molecules forming the constituent (A) is also not fixed; in particular, the structure of a relatively high molecular weight, i.e. oligomeric or polymeric siloxane, can be linear, cyclic, branched or resin-like, network-like. Linear and cyclic polysiloxanes are preferably made up of units of the formulae R₃SiO_{1/2}, R⁴R₂SiO_{2/2}, R⁴RSiO_{1/2} and R₂SiO_{2/2}, where R and R⁴ are as defined above. Branched and network-like polysiloxanes additionally contain trifunctional and/or tetrafunctional units, with preference being given to those of the formulae RSiO_{3/2}, R⁴SiO_{3/2} and SiO_{4/2}. Of course, mixtures of different siloxanes which satisfy the criteria of constituent (A) can also be used.

As component (A), particular preference is given to using vinyl-functional, essentially linear polydiorganosiloxanes having a viscosity of from 0.01 to 500,000 Pa·s, more preferably from 0.1 to 100,000 Pa·s, in each case at 25° C.

As organosilicon compound (B), it is possible to use all hydrogen-functional organosilicon compounds which are useful in addition-crosslinking compositions. As organopolysiloxanes (B) having Si-bonded hydrogen atoms, preference is given to using linear, cyclic or branched organopolysiloxanes composed of units of the general formula (III)

R_{c}H_{d}SiO_{(4-c-d)/2} (III)

where
R is as defined above,
c is 0, 1, 2 or 3 and
d is 0, 1 or 2,
   with the proviso that the sum of c+d is less than or equal to 3 and at least two Si-bonded hydrogen atoms are present per molecule.

The organopolysiloxane (B) preferably contains Si-bonded hydrogen in a proportion of from 0.04 to 1.7 percent by weight, based on the total weight of the organopolysiloxane (B). The molecular weight of the constituent (B) can likewise vary within wide limits, for instance in the range from 10² to 10⁶ g/mol. Thus, the constituent (B) can be, for example, a relatively low molecular weight SiH-functional oligosiloxane such as tetramethyldisiloxane but can also be a high-polymer polydimethylsiloxane having lateral or terminal SiH groups or a silicone resin having SiH groups.

The structure of the molecules forming the constituent (B) is also not fixed; in particular, the structure of a relatively high molecular weight, i.e. oligomeric or polymeric, SiH-containing siloxane can be linear, cyclic, branched or resin-like, network-like. Linear and cyclic polysiloxanes (B) are preferably made up of units of the formulae R₃SiO_{1/2}, HR₂SiO_{1/2}, HRSiO_{2/2} and R₂SiO_{2/2}, where R is as defined above. Branched and network-like polysiloxanes additionally contain trifunctional and/or tetrafunctional units, with preference being given to those of the formulae RSiO_{3/2}, HSiO_{3/2} and SiO_{4/2}, where R is as defined above.

Of course, it is also possible to use mixtures of different siloxanes which satisfy the criteria of the constituent (B). Particular preference is given to using low molecular weight SiH-functional compounds such as tetrakis(dimethylsiloxy)silane and tetramethylcyclotetrasiloxane and also relatively high molecular weight, SiH-containing siloxanes such as poly(hydrogenmethyl)siloxane and poly(dimethylhydrogenmethyl)siloxane having a viscosity at 25° C. of from 10 to 10,000 mPa·s, or analogous SiH-containing compounds in which part of the methyl groups has been replaced by 3,3,3-trifluoropropyl or phenyl groups.

Constituent (B) is preferably present in the crosslinkable silicone compositions of the invention in such an amount that the molar ratio of SiH groups to aliphatically unsaturated groups from (A) is from 0.1 to 20, more preferably from 1.0 to 5.0.

The components (A) and (B) used according to the invention are commercial products or can be prepared by processes customary in chemistry.

Instead of components (A) and (B), the silicone compositions of the invention can contain organopolysiloxanes (C) which at the same time have aliphatic carbon-carbon multiple bonds and Si-bonded hydrogen atoms. It is also possible for the silicone compositions of the invention to contain all three components (A), (B) and (C).

If siloxanes (C) are used, they are preferably siloxanes composed of units of the general formulae (IV), (V) and (VI)

R_{f}SiO_{4-f/2} (IV)

R_{g}R⁴SiO_{3-g/2} (V)

RₕHSiO_{3-h/2} (VI)

where
R and R⁴ are as defined above,
f is 0, 1, 2 or 3,
g is 0, 1 or 2 and
h is 0, 1 or 2,
   with the proviso that at least 2 radicals R⁴ and at least 2 Si-bonded hydrogen atoms are present per molecule.

Examples of organopolysiloxanes (C) are siloxanes composed of SiO_{4/2}, R₃SiO_{1/2}, R₂R⁴SiO_{1/2} and R₂HSiO_{1/2} units, known as MQ resins, with these resins additionally being able to contain RSiO_{3/2} and R₂SiO units, and also linear organopolysiloxanes consisting essentially of R₂R⁴SiO_{1/2}, R₂SiO and RHSiO units, where R and R⁴ are as defined above. The organopolysiloxanes (C) preferably have an average viscosity of from 0.01 to 500,000 Pa·s, more preferably from 0.1 to 100,000 Pa·s, in each case at 25° C. Organopolysiloxanes (C) can be prepared by methods customary in chemistry.

As catalysts (D) which promote the addition of Si-bonded hydrogen onto aliphatic multiple bonds, all catalysts (D) which are useful for promoting the addition of Si-bonded hydrogen onto aliphatic multiple bonds can be used in the process of the invention. The catalysts are preferably a metal from the group of the platinum metals or a compound or a complex from the group of the platinum metals. Examples of such catalysts (D) are metallic and finely divided platinum which may be present on supports such as silicon dioxide, aluminium oxide or activated carbon, compounds or complexes of platinum such as platinum halides, e.g. PtCl₄, H₂PtCl₆.6H₂O, Na₂PtCl₄.4H₂O, platinum-olefin complexes, platinum-phosphite complexes, platinum-alcohol complexes, platinum-alkoxide complexes, platinum-ether complexes, platinum-aldehyde complexes, platinum-ketone complexes including reaction products of H₂PtCl₆.6H₂O and cyclohexanone, platinum-vinylsiloxane complexes such as platinum-1,3-divinyl-1,1,3,3-tetramethyldisiloxane complexes with or without a content of detectable inorganically bound halogen, bis(gamma-picoline)platinum dichloride, trimethylenedipyridineplatinum dichloride, dicyclopentadieneplatinum dichloride, dimethylsulfoxide ethyleneplatinum(II) dichloride, cyclooctadieneplatinum dichloride, norbornadieneplatinum dichloride, gamma-picolineplatinum dichloride, cyclopentadieneplatinum dichloride, and also reaction products of platinum tetrachloride with olefin and primary amine or secondary amine or primary and secondary amine, for example the reaction product of platinum tetrachloride dissolved in 1-octene with sec-butylamine, or ammonium-platinum complexes.

In the process of the invention, the catalyst (D) is preferably used in amounts of from 0.5 to 100 ppm by weight (parts by weight per million parts by weight), more preferably in amounts of from 5 to 50 ppm by weight, in each case calculated as elemental platinum and based on the total weight of the silicone composition.

As component (K), it is possible to use all hydroperoxides known in the prior art, for example cumene hydroperoxide, tert-butyl hydroperoxide, pinane hydroperoxide, 5-phenyl-4-pentenyl hydroperoxide, 2-butanone peroxide (1-[(1-hydroperoxy-1-methylpropyl)peroxy]-1-methylpropyl hydroperoxide), etc. Preference is given to compounds which contain both at least one hydroperoxy group and at least one peroxy group, e.g. 2-butanone peroxide.

As component (L), it is possible to use any acetylenic alcohol, for example those known in the art. Suitable examples are 1-ethynyl-1-cyclohexanol, 2-methyl-3-butyn-2-ol and 3,5-dimethyl-1-hexyn-3-ol or 3-methyl-1-dodecyn-3-ol. Preference is given to using 1-ethynylcyclohexanol as component (L).

Apart from the abovementioned components (A), (B), (C), (D), (K) and (L), further components (E) or (F) can be additionally present in the silicone compositions of the invention.

Components (E) such as inhibitors and stabilizers which are different from (K) and (L) serve to set the processing time, start temperature and crosslinking rate of the silicone compositions of the invention in a targeted manner. These inhibitors and stabilizers are very well known in the field of addition-crosslinking compositions. Examples of customary inhibitors are polymethylvinylcyclosiloxanes such as 1,3,5,7-tetravinyltetramethyl-tetracyclosiloxane, low molecular weight silicone oils having methylvinyl-SiO_{1/2} groups and/or R₂vinylSiO_{1/2} end groups, e.g. divinyltetramethyldisiloxane, tetravinyldimethyldisiloxane, trialkyl cyanurates, alkyl maleates such as diallyl maleate, dimethyl maleate and diethyl maleate, alkyl fumarates such as diallyl fumarate and diethyl fumarate, organic peroxides, organic sulfoxides, organic amines, diamines and amides, phosphanes and phosphites, nitriles, triazoles, diaziridines and oximes. The action of these inhibitor additives (E) depends on their chemical structure, so that the concentration has to be determined individually Inhibitors and inhibitor mixtures are preferably added in a proportion of from 0.00001% to 5%, based on the total weight of the mixture, more preferably from 0.00005 to 2% and most preferably from 0.0001 to 1%. The compositions may be free of the optional additional stabilizers and inhibitors.

Components (F) are all further additives which are useful for producing addition-crosslinkable compositions. The silicone composition of the invention can, if desired, contain the component (F) as further additives in a proportion of up to 70% by weight, preferably from 0.0001 to 40% by weight. These additives can be, for example, inactive fillers, resin-like polyorganosiloxanes which are different from the siloxanes (A), (B) and (C), reinforcing and nonreinforcing fillers, fungicides, fragrances, rheological additives, corrosion inhibitors, oxidation inhibitors, light stabilizers, flame retardants and agents for influencing the electrical properties, dispersants, solvents, bonding agents, pigments, dyes, plasticizers, organic polymers, heat stabilizers, etc. These include additives such as quartz flour, diatomaceous earth, clays, chalk, lithopone, carbon blacks, graphite, metal oxides, metal carbonates, sulfates, metal salts of carboxylic acids, metal dusts, metal hydroxides, fibers such as glass fibers, polymer fibers, polymer powders, metal dusts, dyes, pigments, etc.

Examples of reinforcing fillers which can be used as component (F) in the silicone compositions of the invention are pyrogenic or precipitated silicas having BET surface areas of at least 50 m²/g and also carbon blacks and activated carbons such as furnace black and acetylene black, with preference being given to pyrogenic and precipitated silicas having BET surface areas of at least 50 m²/g. The silica fillers mentioned can have hydrophilic character or have been hydrophobicized by known methods. When mixing in hydrophilic fillers, the addition of a hydrophobicizing agent is necessary. The content of actively reinforcing filler (F) in the crosslinkable composition of the invention, for example, may be in the range from 0 to 70% by weight, preferably from 0 to 50% by weight.

The silicone compositions of the invention can, if necessary, be dissolved, dispersed in suspension or emulsified in liquids. The compositions of the invention can, especially depending on the viscosity of the constituents and the filler content, have a low viscosity and be pourable, have a paste-like consistency or be pulverulent or else be pliable, high-viscosity compositions, as known, for example, in the case of compositions frequently denoted among those skilled in the art as RTV-1, RTV-2, LSR and HTV. In particular, the compositions of the invention can, if they have a high viscosity, be converted into the form of a granular material. Here, the individual granule can comprise all components or the components used according to the invention are separately incorporated into different granules. As regards the elastomeric properties of the crosslinked silicone compositions of the invention, the properties encompass the entire spectrum ranging from extremely soft silicone gels, through rubber-like materials to highly crosslinked silicones having glass-like behavior.

The silicone compositions of the invention can be produced by known methods, for example by uniform mixing of the individual components. Any order is possible, but preference is given to uniformly mixing the platinum catalyst (D) with a mixture of (A), (B) and if appropriate (E) and (F). The platinum catalyst (D) and if appropriate (C) used according to the invention can be incorporated as solid or as solution dissolved in a suitable solvent or as masterbatch, viz. mixed uniformly with a small amount of (A), or with (A) together with (E). The components (A), (B), (C), (D), (E), (F), (K) and (L) can, in each case, be a single type of such a component or else a mixture of at least two different types of such a component.

The silicone compositions of the invention which can be crosslinked by addition of Si-bonded hydrogen onto aliphatic multiple bonds can be crosslinked under the same conditions as the previously known compositions which can be crosslinked by means of a hydrosilylation reaction. Preference is given to employing temperatures of from 100 to 220° C., more preferably from 130 to 190° C., and at a pressure of from 900 to 1100 hPa. However, it is also possible to employ higher or lower temperatures and pressures.

The present invention further provides moldings produced by crosslinking the compositions of the invention.

The silicone compositions of the invention and also the crosslinked products produced therefrom according to the invention can be used for all purposes for which organopolysiloxane compositions which can be crosslinked to give elastomers or such elastomers are useful. These encompass, for example, silicone coating or impregnation of any substrates, the production of moldings, for example by injection molding processes, vacuum extrusion processes, extrusion processes, casting and compression molding and taking casts, and use as sealing compositions, embedding compositions and potting compositions etc.

The crosslinkable silicone compositions of the invention have the advantage that they can be produced in a simple process using readily available starting materials and thus economically. The crosslinkable compositions of the invention have the further advantage that they have a very good storage stability as one-component formulations at 25° C. and ambient pressure and crosslink quickly only at elevated temperature. The two components (K) and (L) surprisingly display a synergistic effect in respect of the storage stability. The silicone compositions of the invention have the advantage that in the case of two-component formulations they give, after mixing the two components, a crosslinkable silicone compositions whose processability is maintained over a long period of time at 25° C. and ambient pressure, i.e. compositions which display extremely long pot lives and crosslink rapidly only at elevated temperature.

Furthermore, the compositions of the invention have the advantage that the crosslinked silicone rubbers obtained therefrom have excellent transparency, and that the hydrosilylation reaction does not become slower with duration of the reaction.

### Examples

In the examples described below, all parts and percentages are, unless indicated otherwise, by weight. Unless indicated otherwise, the examples below are carried out at the pressure of the surrounding atmosphere, i.e. at about 1000 hPa, and at room temperature, i.e. at about 20° C., or at a temperature which is established when the reactants are combined at room temperature without additional heating or cooling. Any possible mixture of the above-described components (A), (B), (C) and (D) including fillers and additives can be used as base mixture for carrying out the examples since the base mixture has no influence on the values of the “start temperature” and “pot life.” The start temperature reflects the point of commencement of crosslinking at 4% of the final value, with the measurement itself being carried out using a temperature range from 80° C. to 200° C. and a rate of increase of 10 K/min. At the end of the pot life, the material is no longer processable and replasticization is no longer possible.

Table 1 shows the synergistic action of the combination of one or more acetylenic alcohols (L) with one or more hydroperoxides (K). Additives, Si—H crosslinkers and catalysts can be mixed in any desired order, with the addition of the catalyst preferably occurring after addition of the additives.

A crosslinkable base mixture is produced from the above-mentioned constituents vinyl polymer, Si—H crosslinker, fillers, with the composition of the mixture having no or only slight influence on the relevant parameters pot life and start temperature. All abovementioned mixing ratios are permissible for production of this base mixture. In the present examples, the Karstedt catalyst (platinum-1,3-divinyl-1,1,3,3-tetra-methyldisiloxane complexes) is used, but it is also possible to use all other known catalysts of the platinum group. The indicated amounts of the hydroperoxides are in each case based on the sum of the solutions or mixtures used and the following abbreviations are employed:

2-butanone peroxide: 50-60% strength in diacetone alcohol (BPO)
tert-butyl hydroperoxide: 5-6 M in decane (tBuHPO)
cumene hydroperoxide: technical-grade 80% strength (CHPO)
Ex. No. (Example number)
Cat. (catalyst)
RT (room temperature)
n.c.o. (not carried out)
ECH: 1-ethynylcyclohexanol

TABLE 1

| | Cat | | Hydro- | Start | | |
|---|---|---|---|---|---|---|
| Ex. | in | Inhibitor | peroxide | temperature | Pot life in days | |
| No. | ppm | in ppm | in % | in ° C. | at 50° C. | at RT |
| 1* | 5 | 500 (ECH) | 0 | 108 | 3 | 41 |
| 2 | 5 | 500 (ECH) | 0.01 (BPO) | 119 | 3 | 75 |
| 3 | 5 | 500 (ECH) | 0.05 (BPO) | 140 | 11 | 250 |
| 4 | 5 | 500 (ECH) | 0.1 (BPO) | 153 | 25 | >360 |
| 5* | 5 | 0 (ECH) | 0.05 (BPO) | 86 | 0.3 | 5 |
| 6* | 5 | 0 (ECH) | 0.1 (BPO) | 92 | 2 | 47 |
| 7 | 5 | 50 (ECH) | 0.2 (BPO) | 107 | 2 | 80 |
| 8 | 5 | 50 (ECH) | 0.3 (BPO) | 115 | 4 | 101 |
| 9 | 5 | 50 (ECH) | 0.4 (BPO) | 136 | 10 | 164 |
| 10* | 0 | | 1 (BPO) | not | n.c.o. | n.c.o. |
| | | 0 | | crosslinked | | |
| 11 | 5 | 100 (ECH) | 0.2 (BPO) | 114 | 2 | 73 |
| 12 | 5 | 150 (ECH) | 0.2 (BPO) | 126 | 4 | 101 |
| 13 | 5 | 200 (ECH) | 0.2 (BPO) | 133 | 7 | 136 |
| 14 | 5 | 500 (ECH) | 0.01 | 122 | 4 | 70 |
| | | | (tBuHPO) | | | |
| 15 | 5 | 500 (ECH) | 0.05 | 145 | 8 | 200 |
| | | | (tBuHPO) | | | |
| 16 | 5 | 500 (ECH) | 0.1 (tBuHPO) | 150 | 15 | >360 |
| 17* | 0 | 0 | 1 (tBuHPO) | not | n.c.o. | n.c.o. |
| | | | | crosslinked | | |
| 18 | 5 | 500 (ECH) | 0.01 (CHPO) | 123 | 3 | 65 |
| 19 | 5 | 500 (ECH) | 0.05 (CHPO) | 138 | 9 | 230 |
| 20 | 5 | 500 (ECH) | 0.1 (CHPO) | 144 | 18 | 300 |
| 21* | 0 | 0 | 1 (CHPO) | not | n.c.o. | n.c.o. |
| | | | | crosslinked | | |
| 22* | 5 | 1000 (ECH) | — | 135 | 4 | 120 |
| 23* | 5 | 2000 (ECH) | — | 150 | 5 | 250 |

*not according to the invention

In the examples of Table 1, the base mixture is mixed with the inhibitors (acetylenic alcohol and hydroperoxide) before the platinum catalyst is added.

Table 1 shows the composition and results. Examples 10, 17 and 21 clearly show that the hydroperoxide added serves as inhibitor for the platinum-catalyzed hydrosilylation and that peroxide-induced crosslinking consequently takes place since compositions without platinum catalyst do not crosslink. Examples 5 and 6 show that in the case of the sole use of hydroperoxide as inhibitor, the hydrosilylation is not sufficiently inhibited without addition of acetylenic alcohol. However, if a combination of acetylenic alcohol and hydroperoxide is added to the mixtures (Examples 2, 3, 4, 14, 15, 16, 18, 19, 20), it is possible, in particular, to achieve an overproportionate increase in the room-temperature pot life. Surprisingly, a synergistic effect is observed as a result of the combination of the two inhibitors. The start temperature of these mixtures increases only moderately in comparison with the pot life (particularly the room-temperature pot life). A further advantage arising from the combination of the two classes of compounds is that a significantly smaller total amount of inhibitors has to be mixed in in order to obtain the same pot life. Particularly when the materials are used as insulating materials, this is a significant advantage (a smaller amount of dissociation products and by-products is formed).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An addition-crosslinking composition comprising at least one compound bearing at least two unsaturated carbon-carbon bonds and at least one organosilicon compound containing at least two Si-bonded hydrogen atoms, wherein
(A) is an organic compound or an organosilicon compound containing at least two radicals having aliphatic carbon-carbon multiple bonds,
(B) is an organosilicon compound containing at least two Si-bonded hydrogen atoms,
(C) is an organosilicon compound containing SiC-bonded radicals having aliphatic carbon-carbon multiple bonds and Si-bonded hydrogen atoms,
(D) is a platinum catalyst,
(K) is a hydroperoxide,
(L) is an acetylenic alcohol,
the composition comprising at least one compound each of (A), (B), (D), (K), and (L); at least one compound each of (C), (D), (K), and (L); or at least one compound each of (A), (B), (C), (D), (K), and (L).

2. The addition-crosslinking silicone composition of claim 1, further comprising, as a component (E), at least one inhibitor or stabilizer different from (K) and (L) in a proportion of from 0.00001% to 5% based on the total weight of the composition.

3. The addition-crosslinking silicone composition of claim 1, further comprising at least one component (F) selected from the group consisting of reinforcing and nonreinforcing fillers, dispersants, solvents, bonding agents, pigments, dyes, plasticizers, organic polymers, heat stabilizers, fungicides, fragrances, rheological additives, corrosion inhibitors, oxidation inhibitors, light stabilizers, flame retardants and agents for influencing electrical properties.

4. The addition-crosslinking silicone composition of claim 2, further comprising at least one component (F) selected from the group consisting of reinforcing and nonreinforcing fillers, dispersants, solvents, bonding agents, pigments, dyes, plasticizers, organic polymers, heat stabilizers, fungicides, fragrances, rheological additives, corrosion inhibitors, oxidation inhibitors, light stabilizers, flame retardants and agents for influencing electrical properties.

5. A process for producing an addition-crosslinking silicone composition of claim 1, comprising mixing
at least one compound each of (A), (B), (D), (K) and (L), or
at least one compound each of (C), (D), (K) and (L), or
at least one compound each of (A), (B), (C), (D), (K) and (L).

6. The process of claim 5, further comprising mixing into the addition-crosslinking silicon composition at least one further component selected from the group consisting of (E) and (F).

7. In a process for the production of silicone moldings, silicone coatings, silicon casts, or for impregnating, sealing, embedding, or potting, wherein a crosslinkable organosilicon composition is used, the improvement comprising employing, as a crosslinkable organosilicon composition, the addition-crosslinking composition of claim 1.
